(19) United States
(12) Patent Application Publication
(10) Pub. No.: US 2025/0272638 A1
(43) Pub. Date: Aug. 28, 2025

(54) E-COMMERCE INTELLIGENT CLOUD-BASED INFORMATION DISTRIBUTION SYSTEM

(71) Applicant: XUHUI CAI, SINGAPORE (SG)

(72) Inventor: XUHUI CAI, SINGAPORE (SG)

(21) Appl. No.: 18/585,445

(22) Filed: Feb. 23, 2024

(51) Int. Cl. G06Q 10/0633

(52) U.S. Cl. CPC G06Q 10/0633

(57) ABSTRACT

An E-commerce intelligent cloud-based information distribution system includes a distribution request unit, a request monitoring unit, a request identification unit, an information distribution unit, a cloud server unit, an exception analysis unit, an exception recording unit, an exception processing unit, an exception feedback unit, a cloud-based information receiving unit, and a central control processing unit. The request identification unit includes a data receiving module, a data element extraction module, a data queue sending module, a task requirement extraction module, a task adaptive processing module, and a data sending module. The present disclosure sends the could-based information into the corresponding sending queue based on the characteristics of the received could-based information and the requirements of different platforms; and then the could-based information is adaptively tailored according to the link status and network bandwidth, and the adaptive distribution of the could-based information is realized under the constraints of the task scenario.

The present disclosure relates to a technical field of information distribution, and more particular to an E-commerce intelligent cloud-based information distribution system.

### BACKGROUND

As E-commerce develops towards informatization, intelligence and cloud data, requirements for cloud-based information processing are gradually increased. Amounts of information in a data link network exponentially grows; rapidly and accurately processing and distribution to the information have become critical technical problems.

In a patent with publication number CN114861112B, an information distribution method and system based on data access and big data classification are provided. The patent identifies interactive events of target cloud service data with AI technology in advance to obtain event disassembly information. The event disassembly information can be applied to a classification of target cloud service data at an event level. When an information distribution request is received, the corresponding target interaction event can be determined based on the request, thereby to extract and filter a specified cloud service data from the target cloud service data based on a target interaction event and event disassembly information, and thereafter the specified cloud service data are distributed. As such, the above design can accurately locate the specified cloud service data can be accurately positioned at the event level to improve an efficiency and intelligence of the data distribution.

The distribution of cloud-based information needs to consider various factors including usage scenarios, message characteristics, platform roles, information characteristics, link characteristics, network conditions, etc. Above distribution system has insufficient adaptability to different types of request information, frequency of requests, timing of requests, and status and types of platforms. Therefore, application scenarios are limited.

### SUMMARY

The present disclosure provides an E-commerce intelligent cloud-based information distribution system, aiming to solve above technical problems.

An E-commerce intelligent cloud-based information distribution system includes a distribution request unit, a request monitoring unit, a request identification unit, an information distribution unit, a cloud server unit, an exception analysis unit, an exception recording unit, an exception processing unit, an exception feedback unit, a cloud-based information receiving unit, and a central control processing unit.

The request identification unit includes a data receiving module, a data element extraction module, a data queue sending module, a task requirement extraction module, a task adaptive processing module, and a data sending module; the request identification unit is configured to orchestrate and process cloud information sending requests for different information scenarios and task requirements.

Optionally, the distribution request unit is configured to generate a request data when information distribution is required, and send the request data to the information distribution unit and the request monitoring unit; the request monitoring unit is configured to determine an authenticity of the request data and intercept false sending requests. Areal request data will be sent to the request identification unit for judgment.

Optionally, the data receiving module of the request identification unit is configured to receive the request data sent by the request monitoring unit, and send the request data to the data element extraction module; the data element extraction module of the request identification unit is configured to extract attributes and topics of the requested data; The task requirement extraction module of the request identification unit is configured to extract a degree of requirement of the request data on a platform.

Optionally, the data queue sending module of the request identification unit is configured to classify a sending queue of request data according to attributes and topics of the request data and needs of the platform; the task adaptive processing module of the request identification unit is configured to regulate and organize the queue according to changes of the request data and needs of the platform; the data sending module of the request identification unit is configured to successively send the request data to the cloud-based information distribution unit according to the classified sending queue.

Optionally, the information distribution unit is configured to retrieve cloud-based information from the cloud server unit according to the request data and send the cloud-based information to the cloud-based information receiving unit through the central control processing unit.

Optionally, the exception analysis unit is configured to receive an exception cloud-based information sent from the central control processing unit to the cloud-based information receiving unit and perform exception analysis and traceability based on the data of the cloud-based information; the exception recording unit is configured to record results of exception analysis.

Optionally, the exception processing unit is configured to process the exception data sent by the exception analysis unit and send a processing result to the exception feedback unit; the exception feedback unit is configured to feed exception data processing results back to the central control processing unit.

According to the present disclosure, the E-commerce intelligent cloud-based information distribution system extracts the characteristics, attributes, and subject content of the received cloud-based information through the request identification unit, and considers the cloud-based information requirements of different platforms and arranges the cloud-based information into different sending queues; when a the cloud-based information is sent, the cloud-based information is adaptively tailored according to the link status and network bandwidth, and adaptive distribution of the message is achieved under the constraints of the task scenario.

### BRIEF DESCRIPTION OF DRAWINGS

FIG. 1 is a block diagram of the cloud information distribution system of the present disclosure.

FIG. 2 is a block diagram of the request identification unit of the present disclosure.

FIG. 3 is a workflow chart of the request identification unit of the present disclosure.

Reference numerals in the drawing: 1: a distribution request unit; 2: a request monitoring unit; 3: a request identification unit; 4: an information distribution unit; 5: a cloud server unit; 6: an exception analysis unit; 7: an exception recording unit; 8: an exception processing unit; 9: an exception feedback unit; 10: a cloud-based information receiving unit; 11: and a central control processing unit; 12: a data receiving module; 13: a data element extraction module; 14: a data queue sending module; 15: a task requirement extraction module; 16: a task adaptive processing module; 17: a data sending module.

### DETAILED DESCRIPTION

Technical solutions in the embodiments of the present disclosure will be described clearly and completely in the following by referring to the accompanying drawings of the present disclosure. Apparently, the described embodiments are only a part of but not all the embodiments of the present disclosure. All other embodiments, which are obtained by any ordinary skilled person in the art based on the embodiments in the present disclosure without making creative work, shall fall within the protection scope of the present disclosure.

### Embodiment 1

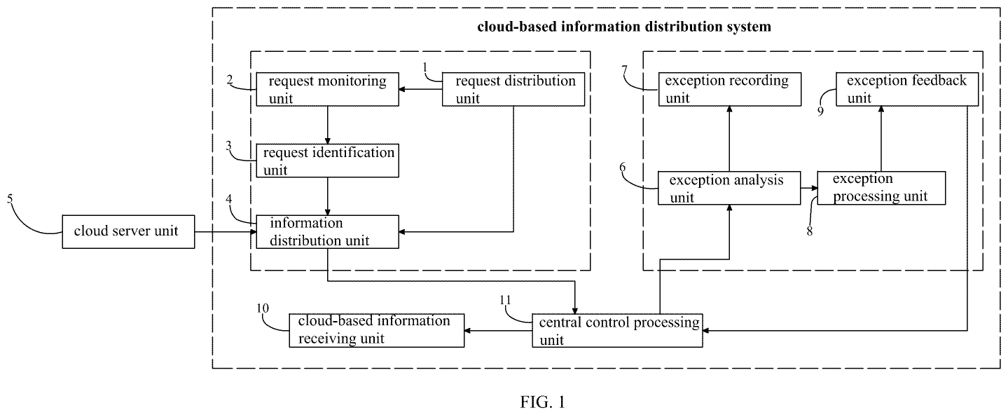

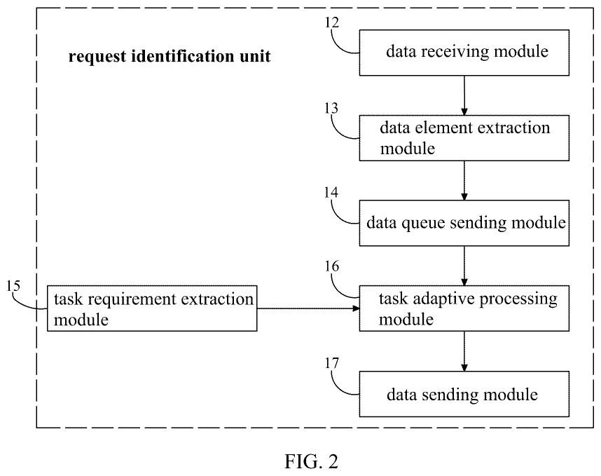

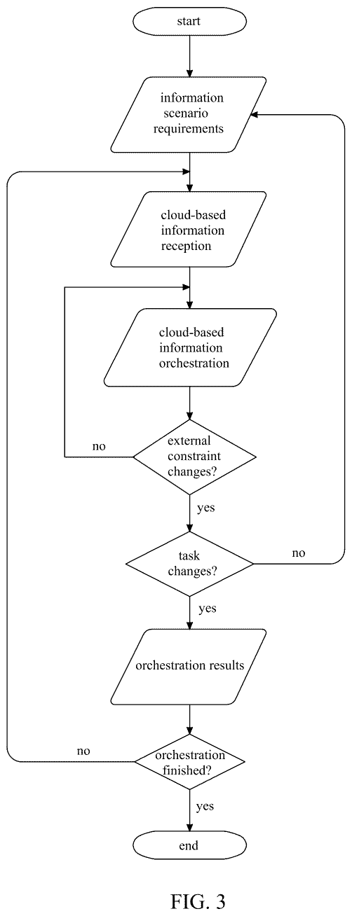

In the present embodiment, as shown in FIG. 1, FIG. 2, and FIG. 3, an E-commerce intelligent cloud-based information distribution system includes a distribution request unit 1, a request monitoring unit 2, a request identification unit 3, an information distribution unit 4, a cloud server unit 5, an exception analysis unit 6, an exception recording unit 7, an exception processing unit 8, an exception feedback unit 9, a cloud-based information receiving unit 10, and a central control processing unit 11.

The request identification unit 3 includes a data receiving module 12, a data element extraction module 13, a data queue sending module 14, a task requirement extraction module 15, a task adaptive processing module 16, and a data sending module 17; the request identification unit is configured to orchestrate and process cloud information sending requests for different information scenarios and task requirements.

As shown in FIG. 2 and FIG. 3, the distribution request unit 1 is configured to generate a request data when information distribution is required, and send the request data to the information distribution unit 4 and the request monitoring unit 2; the request monitoring unit 2 is configured to determine the authenticity of the request data and intercept false sending requests. The real request data will be sent to the request identification unit 3 for judgment.

The data receiving module 12 of the request identification unit 3 is configured to receive the request data sent by the request monitoring unit 2, and send the request data to the data element extraction module 13; the data element extraction module 13 of the request identification unit is configured to extract attributes and topics of the requested data; the task requirement extraction module 15 of the request identification unit 3 is configured to extract the degree of requirement of the request data on the platform. The data queue sending module 14 of the request identification unit 3 is configured to classify the sending queue of request data according to attributes and topics of the request data and needs of the platform; the task adaptive processing module 16 of the request identification unit 3 is configured to regulate and organize the queue according to changes of the request data and needs of the platform; the data sending module 17 of the request identification unit 3 is configured to successively send the request data to the cloud-based information distribution unit 4 according to the classified sending queue.

As shown in FIG. 3, the workflows of the request identification unit 3 are as follows:
1, firstly obtain the constraints of the task scenario on the requested data;
2, when request data arrives, the components of the request data are decomposed and the constraints and process relationships between the elements are analyzed;
3, construct a request data topology diagram based on the relationship between the elements of the request data, and provide the request data arrangement results. When external constraints such as link bandwidth or network node topology change or task scenario constraints change, the request data processing flow topology needs to be reconstructed; and the request data processing process needs to be reorganized.

The information distribution unit 4 is configured to retrieve cloud-based information from the cloud server unit 5 according to the request data and send the cloud-based information to the cloud-based information receiving unit 10 through the central control processing unit 11. The exception analysis unit 6 is configured to receive the exception cloud-based information sent from the central control processing unit 11 to the cloud-based information receiving unit 10 and perform exception analysis and traceability based on the data of the cloud-based information; the exception recording unit 7 is configured to record results of exception analysis. The exception processing unit 8 is configured to process the exception data sent by the exception analysis unit 6 and send a processing result to the exception feedback unit 9; the exception feedback unit 9 is configured to feed exception data processing results back to the central control processing unit 11.

Although the embodiments of the present disclosure have been shown and described, any ordinary skilled person in the art can perform various changes, modifications, substitutions, and variations on the embodiments without departing from the principles and spirit of the present disclosure. The scope of the present disclosure is limited by the appended claims and equivalents thereof.

We claim:

1. An E-commerce intelligent cloud-based information distribution system, comprising:
a distribution request unit;
a request monitoring unit;
a request identification unit; wherein the request identification unit comprises a data receiving module, a data element extraction module, a data queue sending module, a task requirement extraction module, a task adaptive processing module, and a data sending module; the request identification unit is configured to orchestrate and process cloud information sending requests for different information scenarios and task requirements;
an information distribution unit;
a cloud server unit;
an exception analysis unit;
an exception recording unit;
an exception processing unit;
an exception feedback unit;
a cloud-based information receiving unit; and
a central control processing unit.

2. The E-commerce intelligent cloud-based information distribution system according to claim 1, wherein the distribution request unit is configured to generate a request data when information distribution is required, and send the request data to the information distribution unit and the request monitoring unit; the request monitoring unit is configured to determine an authenticity of the request data and intercept false sending requests, and a real request data will be sent to the request identification unit for judgment.

3. The E-commerce intelligent cloud-based information distribution system according to claim 1, wherein the data receiving module of the request identification unit is configured to receive the request data sent by the request monitoring unit, and send the request data to the data element extraction module; the data element extraction module of the request identification unit is configured to extract attributes and topics of the requested data; the task requirement extraction module of the request identification unit is configured to extract a degree of requirement of the request data on a platform.

4. The E-commerce intelligent cloud-based information distribution system according to claim 1, wherein the data queue sending module of the request identification unit is configured to classify a sending queue of the request data according to attributes and topics of the request data and needs of the platform; the task adaptive processing module of the request identification unit is configured to regulate and organize the queue according to changes of the request data and needs of the platform; the data sending module of the request identification unit is configured to successively send the request data to the cloud-based information distribution unit according to the classified sending queue.

5. The E-commerce intelligent cloud-based information distribution system according to claim 1, wherein the information distribution unit is configured to retrieve cloud-based information from the cloud server unit according to the request data and send the cloud-based information to the cloud-based information receiving unit through the central control processing unit.

6. The E-commerce intelligent cloud-based information distribution system according to claim 1, wherein the exception analysis unit is configured to receive an exception cloud-based information sent from the central control processing unit to the cloud-based information receiving unit, and perform exception analysis and traceability based on the data of the cloud-based information; the exception recording unit is configured to record results of exception analysis.

7. The E-commerce intelligent cloud-based information distribution system according to claim 1, wherein the exception processing unit is configured to process the exception data sent by the exception analysis unit and send a processing result to the exception feedback unit; the exception feedback unit is configured to feed exception data processing results back to the central control processing unit.
